(19) United States
(12) Patent Application Publication
(10) Pub. No.: US 2009/0112837 A1
(43) Pub. Date: Apr. 30, 2009

(54) Proactive Content Dissemination to Users

(76) Inventors: Natwar Modani, Gurgaon (IN); Anupam Saronwala, New Delhi (IN); Sougata Mukerjea, New Delhi (IN); Gyana Ranjan Parija, Gurgaon (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/923,100

(22) Filed: Oct. 24, 2007

(51) Int. Cl. G06F 17/30

(52) U.S. Cl. 707/5; 707/E17.014

(57) ABSTRACT

A content repository of a system stores items of content to be disseminated to users. The content repository generates a content profile for each item of content as the item of content is received. The content profile for each item of content includes information regarding the item of content. A user repository of the system generates and stores a user profile for each user. The user profiles are generated from one or more information sources. The user profile for each user includes information regarding the user. A recommendation engine of the system determines which items of content should be delivered to each user based on the content profiles of the items of content and on the user profile of each user, to yield relevant items of content for each user. The recommendation engine then delivers the relevant items of content to each user.

### FIELD OF THE INVENTION

The present invention relates generally to disseminating content to users, and more particularly to such dissemination of content that is proactive. For instance, as new information regarding a user is obtained, content relevant to this new information may be delivered to the user without any direct interaction by the user.

### BACKGROUND OF THE INVENTION

United States published patent application no. 2003/0233441 describes an embodiment of an information distribution system is provided that can distribute various types of information without imposing extra workload on users. This information distribution system includes a server device that can access a profile database and an information source database. This server device includes an operation history recorder, a feature extractor, a profiler, an information collector, and an information distributor. Every time a user operates an information device, the server device obtains the operation history of the user. The operation history contains the user identifier, the types of operations, and the text information of the handled document. The server device then linguistically analyzes the text information to extract the feature information. After performing weighting on the feature information, the server device registers the feature information in the profile DB. The server device then obtains information from the information source DB, and extracts the profile corresponding to the information from the profiles registered in the profile DB. The server device then distributes the information to the user having the extracted profile.

Further, information is typically distributed based on a solicitation model. A user may explicitly initiate searching or browsing for information to receive the information, or he or she may explicitly subscribe to a source of information that periodically provides the user with the information. The solicitation model implicitly and inherently presumes that the user knows what kind of information that he or she needs or wants. However, people change their roles frequently and information is being generated so rapidly and so voluminously today that it can become difficult for users to acquire the information that they may need at the right time. Without a way to provide an improved method and system of handling information distribution, the promise of this technology may never be fully achieved.

### SUMMARY OF THE INVENTION

The present invention relates generally to proactive content dissemination to users. A system of an embodiment of the invention includes a content repository, a user repository, and a recommendation engine. The content repository stores items of content to be disseminated to users, and generates a content profile for each item of content as the item of content is received. The content profile for each item of content includes information regarding the item of content. The user repository generates and stores a user profile for each user. The user profiles are generated from one or more information sources. The user profile for each user includes information regarding the user. The recommendation engine determines which items of content should be delivered to each user based on the content profiles of the items of content and on the user profile of each user, to yield relevant items of content for each user. The recommendation engine then delivers the relevant items of content to each user.

A method of an embodiment of the invention generates a content profile for each item of content to be disseminated to users, as the item of content is received. The method dynamically generates a user profile for each user, such that the user profile for the user automatically changes as new information regarding the user is obtained, without direct interaction with the user. A history of the changes made to the user profile are maintained and become part of the user profile. In response to an addition to the items of content, a change to the items of content, and/or a change in the user profiles of the users, the method determines which items of content should be delivered to each user based on the content profiles of the items of content and on the user profiles of the users, to yield relevant items of content for each user. The method delivers the relevant items of content for each user to the user.

In one embodiment, the method is implemented by one or more computer programs. The computer programs may be stored on a computer-readable medium. The computer-readable medium may be a tangible medium, such as a recordable data storage medium, or an intangible medium, such as a modulated carrier signal.

At least some embodiments of the invention provide for advantages over the prior art. A user does not have to know the kinds of information required, and does not have to actively search or browse for this information. Rather, as new information regarding the user is acquired and added to the user profile for the user, and as new items of content are received and have content profiles generated for them, relevant items of content are automatically delivered to the user. For example, a user may be assigned new responsibilities within a company. Once this information is acquired, preferably without direct user interaction, content is automatically delivered to the user that is relevant to these new responsibilities.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system for proactively disseminating information to users, according to an embodiment of the invention.

FIG. 2 is a flowchart of a method for proactively disseminating information to users, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

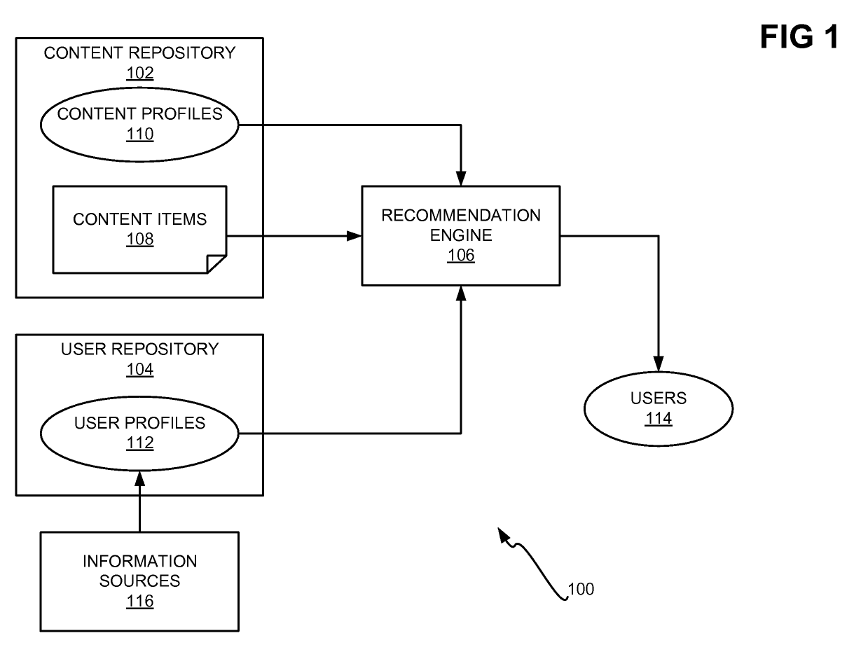

FIG. 1 shows a system 100, according to an embodiment of the invention. The system 100 includes a content repository 102, a user repository 104, and a recommendation engine 106. The repositories 102 and 104 and the recommendation engine 106 may each be implemented in software, hardware, or a combination of software and hardware.

The content repository 102 generates and stores content profiles 110 for content items 108. Each content profile corresponds to a content item. A content item may be a web page, an e-mail, an electronic file, or another type of content item. The content repository 102 receives the content items 108 from various information sources, such as world-wide web pages, internal corporate internets, as well as other types of information sources.

The content profile for each content item includes information regarding the content item apart from the information contained within the content item itself. Thus, the content profile may be considered as including meta-information regarding the information of the content item. The content profile may include information as to the types of users that would benefit from having the information of the content item. In this way, the content profile is used in conjunction with user profiles 112, as will be described. In addition, or alternatively, the content profile may include information as to the type of content to which the information of the content item relates. The content profile may further include an expiration date as to when the corresponding content item should no longer be delivered to any user, where the information of such a content item is timely and automatically irrelevant after a certain date or time has passed.

The content profile for a content item may be generated by parsing the content item, looking for keywords that correspond to a particular type of user. For example, a content item that includes a number of references to a relational database management system (RDBMS) may have a content profile that indicates that the content item is relevant to database-oriented users. The content profile for a content item may be generated based on the information source from which the content item was received. For example, content items received from a sports-oriented web may have content profiles generated for them that indicate that they are relevant to users interested in sports.

The content profiles for the content items may be generated in other ways as well. For instance, more sophisticated approaches may be employed to generate the content profiles. As one example, collaborative filtering and other types of models may be employed to determine the relationship of a first content item to a second content item, such that if there is a high probability of such a relationship, a content profile is generated for the first content item that is similar to or builds upon the content profile that may have already been generated for the second content item.

The user repository 104 generates and stores user profiles 112 for users 114. Each user profile corresponds to a user. The user profiles 112 indicate the type of information that the users would likely be interested in receiving. In addition, or alternatively, the user profiles 112 each indicate the type of user to which the user of the user profile in question relates. The user profiles 112 may be generated from one or more information sources 116 that contain information regarding the users. Such information sources 116 can include structured or semi-structured information sources, such as internal and external databases that include information about the users.

The information sources 116 may contain information about users' roles and responsibilities as well as key performance indicators (KPI's) associated with the users. Furthermore, user's documents, such as documents on a user's machine and a defect queue of the user intended for support personnel, may also be examined to derive the user profile. When statutory requirements regarding privacy concerns can be accommodated, users' email can also be considered to derive the user profile. The information sources 116 may further include user behavior tracking logs, such as the types of web pages that the user has browsed. The information sources 116 may also include explicit input entered by the users themselves in one embodiment.

The user profile for a user is generated dynamically and thus is dynamic, in that the user profile for the user automatically changes as new information regarding the user is received. Furthermore, the user profile for a user is not a current snapshot of the user's content of interest, but also includes and maintains a history of changes made to the user profile such that this history becomes a part of the user profile. For example, a first user may be responsible for database development and have a highly technical background in database technology, whereas a second user may also be responsible for database development but may have from a business-oriented, less technical background in database technology. The first user's user profile may indicate that more sophisticated database-related content items are relevant to the first user, whereas the second user's user profile may not indicate that more sophisticated database-related content items are relevant to the second user.

It is noted that the user profile for a user may be generated dynamically without direct interact with the user. The user repository 104 may be in continual receipt of changing information from the information sources 116. In addition, or alternatively, the user repository 104 may actively scan relevant information sources 116 to determine if any information regarding the users 114 has been changed or has been updated, necessitating a corresponding change in the user profiles 112. In this way, the user is not responsible for ensuring that the corresponding user profile remains up-to-date.

The recommendation engine 106 generally determines which of the content items 108 are relevant for each of the users 114 based on the content profiles 110 for the content items 108 and the user profiles 112 for the users 114. For each user, the recommendation engine 106 then delivers the relevant content items to the user. For instance, such content delivery may include sending an electronic mail or an instant message to the user with the content attached, or with a link to the relevant content. As another instance, such content delivery may include updating a web page for the user with the relevant content, such that when the user next visits the web page, the user learns of the new content items that are available for review.

In general, the recommendation engine 106 determines which content items 108 are relevant to a particular user by matching the user's user profile with the content profiles 110 for the content items 108. The recommendation engine 106 may in one embodiment include several recommendation subsystems, each of which may use a different approach to generate recommendations for content from the one or more information sources. As such, a number of varied approaches can be performed to yield this information. For each determined relevant content item, a recommendation subsystem may generate a confidence score and an accuracy score. The confidence score indicates the confidence that the subsystem in question has in the relevant of the content item in question to the user, whereas the accuracy score indicates how accurate the determination that the content item is relevant to the user is. These two scores may be balanced or combined in some manner, such that just the content items 108 surpassing a threshold are considered as relevant to a given user.

Additionally, the recommendation engine 106 may include a unit, which may be referred to as a recommendation aggregation unit, which is not specifically shown in FIG. 1, and which aggregates the recommendations generated by the various recommendation subsystems, in the embodiment where the engine 106 includes a number of such subsystems. A regression model may be employed by the recommendation aggregation unit to combine recommended content from a number of different recommendation subsystems that recommend content from various content sources, by employing confidence and accuracy scores. In one embodiment, however, there may be just one recommendation subsystem, such that no recommendation aggregation unit is needed.

As another example, a rule-based engine may be employed that matches a user's user profile with the content profiles 110 for the content items 108 based on one or more user profile-information need rules. For instance, the content profiles 110 may each indicate the type of content to which its corresponding content item relates, and the user profiles 112 may each indicate the type of user to which it relates. User profile-information need rules in such an example thus are employed to match the former to the latter, by corresponding the types of content different types of users may need.

As a third example, collaborative-filtering based models may be employed that provide recommended content items based on the similarity of a given user profile to one or more other user profiles for which recommended content items have already been provided and which may have already been determined as accurate. For instance, there may already be a large number of user profiles for users that are database-oriented users. If a new user profile is added for a user that is also database-oriented, collaborative filtering may then be employed so that the new user receives similar recommended content as the other database-oriented users do.

As a fourth example, peer group models may be employed so that users replacing other users in job responsibilities automatically receive the same type of content that the other users used to receive. For example, an existing user may be a database manager-type user. If a new user replaces this existing user in database management responsibilities, the new user may automatically receive the types of content that the existing user used to receive.

As a fifth example, user feedback may be incorporated in how recommended content items are generated for users. For instance, when the recommendation engine 106 generates confidence and accuracy scores for content items, and then delivers some of these content items to a given user, the user may be afforded the opportunity to indicate how relevant each of these content items were. Such user feedback can then be employed to generate confidence and accuracy scores for future content items, such as by using a Bayesian or other model that can incorporate such feedback.

User feedback can also be part of a web portal, in which a user can personalize his or her content interests. Such personalization can enable the recommendation engine 106 to provide more relevant content items to the user. In addition, the user may be able to override the recommendation engine 106. For instance, the user may specifically subscribe to one or more types of content items, pursuant to a publish-subscribe model, so that the user always receives these particular types of content items, even if the recommendation engine 106 may not think them relevant to the user.

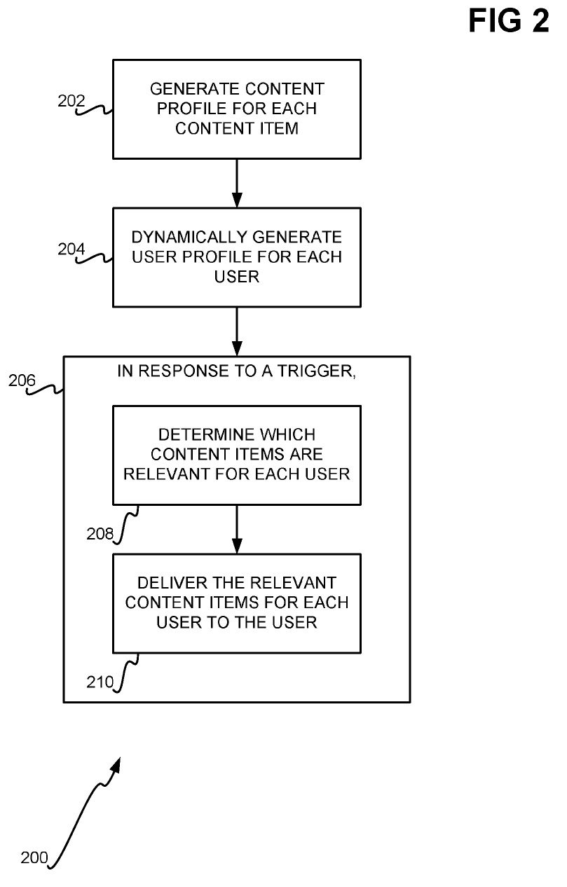

FIG. 2 shows a method 200, according to an embodiment of the invention. A content profile is generated for each content item (202), as has been described previously. Content profiles are generated for content items as the content items are received. Likewise, a user profile is dynamically generated for each user (204), as has also been described previously. As information regarding a user is received, changes, or is updated, the user profile for the user is corresponding updated, where a history of the user profile is maintained and becomes part of the user profile.

Thereafter, the method 200 performs parts 208 and 210 in response a trigger (206). The trigger may be a content item having been added or changed, such that a corresponding content profile is newly created or updated. For this trigger, parts 208 and 210 are performed in relation to the newly created or updated content profile, vis-à-vis all user profiles. The trigger may also be a user profile having been added or changed. For this trigger, parts 208 and 210 are performed in relation to all the content profiles, vis-à-vis the newly created or updated user profile.

Thus, the method 200 determines which content items in question are relevant for the users (208). This determination is made on the basis of the content profiles for the content items and on the user profiles for the users, as has been described previously. The result of part 208 is the identification of a number of relevant content items for each user. Therefore, the method 200 delivers the relevant content items for each user to the user in question (210). Such delivery may be achieved by electronic mail, instant message, and so on, as has been described.

A particular implementation of one embodiment of the present invention is now described, in relation to the previously described FIG. 1. In this implementation, the system 100 includes the content repository 102, the user repository 104, and the recommendation engine 106. Each of these components of the system 100 is now described in more detail.

With respect to the content repository 102, the repository 102 may include multiple heterogeneous content sources, such as the world-wide web of the Internet, an enterprise intranet, proprietary databases, and/or other types of content sources. For each content item 108, the system 100 stores a content profile 110, which may be implemented as a set of keywords associate with the content item 108 in question, and/or a phrase or term within an ontology associated with this content item 108. Such keywords in particular may be supplied by an author of the content item 108, by an expert in the subject matter of the content item 108, or may be derived automatically. Automatic derivation may be performed by using techniques such as term frequency-inverse document frequency (TF-IDF), as can be appreciated by those of ordinary skill within the art. The content sources may further be combined using a federal model.

With respect to the user repository 104, each user profile 112 can be derived from a variety of sources that include information about the roles and responsibilities of the user as well as the user's recent activities. For instance, many enterprises today require employees to document their KPI's, which is thus a reliable source of information about the current interests of the user. In addition, for support personnel, the system 100 may also examine the defect, or bug, queue assigned to the user to determine his or her information needs. Information from such information sources can be combined with more traditional types of information sources, such as web-browsing histories, as well as explicit inputs from the user, to derive the user profile 112 of the user. The user profile 112 may further include past activities, interests, and knowledge of the user, so that recommendations can be filtered to remove or segregate content items of which the user is likely to be aware.

In one embodiment, the user profile 112 for a particular user may be represented by two parts. One part may describe the current information needs of the user in question. By comparison, the other part may describe the current knowledge level of the user. As with the content profiles 110, the user profiles 110 may be represented in one or more sets of keywords.

The recommendation engine 106 may be implemented as having two types of entities: recommender subsystems and a recommendation aggregator. Each recommender subsystem may operate on one or more content sources using one or more specific techniques—such as a collaborative filtering technique, a rule-based technique, a peer group-based technique, and/or a content-based filtering technique—in conjunction with a user profile 112 to generate content recommendations for the user in question. The recommender subsystems may further assign a confidence and accuracy score to each recommendation. The recommendation aggregator could then use these scores, as well as a weight for each recommendation subsystem, to rank the recommendations and communication ordered recommendations to the user. The user may further provide feedback regarding the quality of the recommendations, which may then be used to adjust the weights of the recommendations subsystems.

Those of ordinary skill within the art can appreciate that other implementations of embodiments of the invention can be achieved, in addition to and/or in lieu of the implementation that has been described above. It is thus noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

1. A system comprising:
a content repository configured to store a plurality of items of content to be disseminated to users, and store a content profile for each item of content as the item of content is received by the content repository, the content profile for each item of content including information regarding the item of content;
a user repository configured to generate and store a user profile for each user, the user profile for each user generated from one or more information sources, the user profile for each user including information regarding the user; and,
a recommendation engine configured to determine which of the plurality of items of content should be delivered to each user based on the content profiles of the plurality of items of content and on the user profile of each user, to yield relevant items of content for each user, the recommendation engine to deliver the relevant items of content to each user,
wherein delivery of the relevant items of content to each user is triggered by changes in the user profile for the user.

2. The system of claim 1, all the limitations of which are incorporated herein by reference, wherein delivery of the relevant items of content to each user is further triggered by additions or changes of the plurality of items of content stored within the content repository.

3. The system of claim 1, all the limitations of which are incorporated herein by reference, wherein the user profile for each user is dynamically generated, such that the user profile for the user automatically changes as new information regarding the user is obtained, without direct interaction with the user.

4. The system of claim 3, all the limitations of which are incorporated herein by reference, wherein the user profile for the user automatically changes as new information regarding the user is obtained, without direct interaction with the user, and such that a history of the changes made to the user profile are maintained and become part of the user profile.

5. The system of claim 1, all the limitations of which are incorporated herein by reference, wherein the user repository is to generate the user profile for each user based at least on behavior of the user.

6. The system of claim 1, all the limitations of which are incorporated herein by reference, wherein the user repository is to generate the user profile for each user based at least on one or more of structured information sources and semi-structured information sources within which information regarding the user is located, the information comprising one or more of roles and responsibilities of the users, identified KPI's for the user, work and/or other documents of the user, and a defect queue of the user for support personnel.

7. The system of claim 1, all the limitations of which are incorporated herein by reference, wherein the user repository is to generate the user profile for each user based at least on explicit inputs provided by the user.

8. The system of claim 1, all the limitations of which are incorporated herein by reference, wherein the user repository is to generate the user profile for each user based at least on a history of the user.

9. The system of claim 1, all the limitations of which are incorporated herein by reference, wherein the recommendation engine is to determine which of the plurality of items of content should be delivered to each user based at least on matching the content profiles of the plurality of items of content with information needs encompassed by the user profiles.

10. The system of claim 1, all the limitations of which are incorporated herein by reference, wherein the recommendation engine is to determine which of the plurality of items of content should be delivered to each user by each of a plurality of recommendation subsystems of the recommendation engine at least assigning each item of recommended content for each user a confidence score and an accuracy score, the confidence score denoting a confidence of relevance of the item of content for the user, the accuracy score denoting an accuracy of how relevant the item of content is for the user, the recommendation engine determining the relevant items of content for the user based on a balance of the confidence score and the accuracy score.

11. The system of claim 10, all the limitations of which are incorporated herein by reference, wherein the recommendation engine is to determine which of the plurality of items of content should be delivered to each user by at least employing a regression model combining the recommended content from the recommendation subsystems.

12. The system of claim 10, all the limitations of which are incorporated herein by reference, wherein the recommendation engine is to adjust weights assigned to the recommendation subsystems by at least incorporating user feedback as to how relevant previously delivered items of content from the recommendation subsystems are.

13. The system of claim 1, all the limitations of which are incorporated herein by reference, wherein the recommendation engine is to determine which of the plurality of items of content should be delivered to each user by each of a plurality of recommendation subsystems of the recommendation engine by employing a different one of: a rule-based engine, a collaborative-filtering model, and a peer group model.

14. A method comprising:
generating a content profile for each item of content from a plurality of items of content to be disseminated to users, as the item of content is received;
dynamically generating a user profile for each user, such that the user profile for the user automatically changes as new information regarding the user is obtained, without direct interaction with the user, such that a history of the changes made to the user profile are maintained and become part of the user profile;
in response to one or more of an addition to the plurality of items of content, a change to the plurality of items of content, and a change in the user profiles of the users:
determining which of the plurality of items of content should be delivered to each user based on the content profiles of the plurality of items of content and on the user profiles of the users, to yield relevant items of content for each user; and,
delivering the relevant items of content determined for each user to the respective user.

15. The method of claim 14, all the limitations of which are incorporated herein by reference, wherein dynamically generating the user profile for each user is based on a set of predefined parameters comprises at least one of:
structured information sources within which information regarding the user is located;
semi-structured information sources within which information regarding the user is located;
a history of the user; or,
explicit inputs provided by the user.

16. The method of claim 14, all the limitations of which are incorporated herein by reference, wherein determining which of the plurality of items of content should be delivered to each user further comprises matching the content profiles of the plurality of items of content with information needs encompassed by the user profiles.

17. The method of claim 14, all the limitations of which are incorporated herein by reference, wherein determining which of the plurality of items of content should be delivered to each user is based on one or more of:
assigning each item of content for each user a confidence score and an accuracy score, and determining the relevant items of content for the user based on a balance of the confidence score and the accuracy score, the confidence score denoting a confidence of relevance of the item of content for the user, the accuracy score denoting an accuracy of how relevant the item of content is for the user;
employing a regression model combining recommended content from a number of content sources;
incorporating user feedback on relevancy of previously delivered items of content are;
employing a rule-based engine;
employing a collaborative-filtering model; and,
employing a peer group model.

18. A computer-readable medium having one or more computer programs stored thereon to perform a method comprising:
generating a content profile for each item of content of a plurality of items of content to be disseminated to users, as the item of content is received;
dynamically generating a user profile for each user, such that the user profile for the user automatically changes as new information regarding the user is obtained, without direct interaction with the user, such that a history of the changes made to the user profile are maintained and become part of the user profile;
in response to one or more of an addition to the plurality of items of content, a change to the plurality of items of content, and a change in the user profiles of the users:
determining which of the plurality of items of content should be delivered to each user based on the content profiles of the plurality of items of content and on the user profiles of the users to yield relevant items of content for each user, by at least matching the content profiles of the plurality of items of content with information needs encompassed by the user profiles; and,
delivering the relevant items of content for each user to the user.

19. The computer-readable medium of claim 18, all the limitations of which are incorporated herein by reference, wherein dynamically generating the user profile for each user is based on one or more of:
structured information sources within which information regarding the user is located;
semi-structured information sources within which information regarding the user is located;
a history of the user; and,
explicit inputs provided by the user.

20. The computer-readable medium of claim 18, all the limitations of which are incorporated herein by reference, wherein determining which of the plurality of items of content should be delivered to each user is based on one or more of:
assigning each item of content for each user a confidence score and an accuracy score, and determining the relevant items of content for the user based on a balance of the confidence score and the accuracy score, the confidence score denoting a confidence of relevance of the item of content for the user, the accuracy score denoting an accuracy of how relevant the item of content is for the user;
employing a regression model combining recommended content from a number of content sources;
incorporating user feedback as to how relevant previously delivered items of content are;
employing a rule-based engine;
employing a collaborative-filtering model; and,
employing a peer group model.
